(19) United States
(12) Patent Application Publication
(10) Pub. No.: US 2005/0075241 A1
(43) Pub. Date: Apr. 7, 2005

(54) Catalyst systems of the ziegler-natta type and a method for production thereof

(76) Inventors: Klaus Fottinger, Mannheim (DE); Guido Funk, Worms (DE); Peter Kolle, Koln-Rodenkirch (DE); Joachim Wulff-Doring, Frankenthal (DE)

Correspondence Address: KEIL & WEINKAUF, 1350 CONNECTICUT AVENUE, N.W., WASHINGTON, DC, 20036, US

(21) Appl. No.: 10/399,232

(22) PCT Filed: Oct. 18, 2001
(86) PCT No.: PCT/EP01/12048

(30) Foreign Application Priority Data
Oct. 20, 2000 (DE) 10052381.1

(51) Int. Cl. B01J 31/00

(52) U.S. Cl. 502/102; 502/103

(57) ABSTRACT

A method for production of catalytic systems of the Ziegler-Natta type is characterised in comprising the following steps: A) bringing an inorganic metal oxide and a magnesium compound of formula MgRₙX₂₋ₙ into contact, where X=independently, fluorine, chlorine, bromine, iodine, hydrogen, NR₂, OR, SR, SO₃R or OC(O)R and R=independently, C₁-C₂₀ linear, branched, or cyclic alkyl, a C₂-C₁₀ alkenyl, an alkylaryl with 1-10 C atoms in the alkyl group and 6-20 C atoms in the aryl group, or a C₆-C₁₈ aryl and n=1 or 2, then, B) bringing the intermediate product obtained in step A) into contact with a halogenating reagent, C) bringing the intermediate product obtained in step B) into contact with a) a tetravalent titanium compound, b) a metallo-organic compound of group 3 of the periodic system and c) optionally, an electron-donor compound and D) washing the product obtained in step C) with an aprotic solvent. The invention further relates to a catalytic system obtained as above and a method for the polymerisation of olefins.

The present invention relates to catalyst systems of the Ziegler-Natta type, to a process for preparing them and to their use for the polymerization of olefins.

Catalyst systems of the Ziegler-Natta type have been known for a long time. These systems are used, in particular, for the polymerization of C₂-C₁₀-alk-1-enes and comprise, inter alia, compounds of polyvalent titanium, aluminum halides and/or aluminum alkyls together with a suitable support material. The preparation of the Ziegler-Natta catalysts is usually carried out in two steps. Firstly, the titanium-containing solid component is prepared. This is subsequently reacted with the cocatalyst. The polymerization is subsequently carried out with the aid of catalysts obtained in this way.

Well-suited polymerization catalysts are described, for example, in WO 97/48742 and WO 99/43722. The Ziegler-Natta catalysts described there make it possible to obtain, for example, polymers having increased bulk densities and a better MFR.

A disadvantage of the catalysts described there is their tendency to form deposits when they are used in slurry processes. Interestingly, this deposit formation is not observed in autoclave experiments, but only occurs in a continuous plant after a few days. Deposits are formed on the reactor walls and the polymerization run therefore has to be interrupted prematurely.

It is an object of the present invention to develop, starting from the Ziegler-Natta catalyst system described in WO 97/48742 and WO 99/43722, an improved catalyst system which no longer has the abovementioned disadvantage of deposit formation in the reactor.

We have found that this object is achieved by an additional work-up step which avoids deposit formation when using the corresponding Ziegler-Natta catalysts. When the catalysts are prepared as described in WO 97/48742 and WO 99/43722, components which can be eluted by means of nonpolar solvents are generally still present. The catalyst obtained in this way can then be used directly for polymerization. However, if a subsequent purification step is added to the preparation process, the above-described problems of deposit formation in the reactor can be avoided.

Accordingly, we have found a process for preparing catalyst systems of the Ziegler-Natta type, which comprises the following steps:
A) bringing an inorganic metal oxide into contact with a magnesium compound MgRₙX₂₋ₙ,
   where X are each, independently of one another, fluorine, chlorine, bromine, iodine, hydrogen, NR₂, OR, SR, SO₃R or OC(O)R, and R are each, independently of one another, a linear, branched or cyclic C₁-C₂₀-alkyl, a C₂-C₁₀-alkenyl, an alkylaryl having 1-10 carbon atoms in the alkyl part and 6-20 carbon atoms in the aryl part or a C₆-C₁₈-aryl and n is 1 or 2,
   and subsequently
B) bringing the intermediate obtained after step A) into contact with a halogenating reagent,
C) bringing the intermediate obtained after step B) into contact with
   a) a tetravalent titanium compound,
   b) an organometallic compound of group 3 of the Periodic Table and
   c) if desired, an electron donor compound, and
D) washing the product obtained in step C) with an aprotic solvent.

In view of the prior art, it was surprising that introduction of the washing step D) enabled the disadvantage of the prior art to be avoided.

The invention further provides catalyst systems of the Ziegler-Natta type which can be prepared by means of the process of the present invention and provides a process for the polymerization or copolymerization of olefins in suspension or solution at from 20 to 150° C. and pressures of from 1 to 100 bar, wherein the polymerization or copolymerization is carried out in the presence of at least one catalyst system according to the present invention and, if desired, an aluminum compound as cocatalyst.

The inorganic metal oxide used is, for example, silica gel, aluminum oxide, a mesoporous material or aluminosilicate, in particular silica gel.

The inorganic metal oxide can have been partially or fully modified prior to the reaction in step A). The support material can, for example, be treated under oxidizing or nonoxidizing conditions at from 100 to 1000° C., in the presence or absence of fluorinating agents such as ammonium hexafluorosilicate. In this way, it is possible, inter alia, to vary the water content and/or OH group content. The support material is preferably dried at from 100 to 700° C. under reduced pressure for from 1 to 10 hours before it is used in the process of the present invention.

In general, the inorganic metal oxide has a mean particle diameter of from 5 to 200 μm, preferably from 10 to 100 μm, and particularly preferably from 20 to 70 μm, a mean pore volume of from 0.3 to 5 ml/g, in particular from 0.8 to 3.0 ml/g and particularly preferably from 0.8 to 2.5 ml/g, and a specific surface area of from 10 to 1000 m²/g, in particular from 150 to 600 m²/g. The inorganic metal oxide can be spherical or granular and is preferably spherical.

The specific surface area and the mean pore volume are determined by nitrogen adsorption in accordance with the BET method, as described, for example, in S. Brunauer, P. Emmett and E. Teller in Journal of the American Chemical Society, 60, (1939), pages 209-319.

In step A), the inorganic metal oxide is reacted with a magnesium compound MgRₙX₂₋ₙ, where R is an independent variable to which reference is made a number of times in the description and which has the following meanings for all compounds: R are each, independently of one another, a linear, branched or cyclic C₁-C₂₀-alkyl, e.g. methyl, ethyl, n-propyl, isopropyl, n-butyl, sec-butyl, isobutyl, tert-butyl, n-pentyl, sec-pentyl, isopentyl, n-hexyl, n-heptyl, n-octyl, n-nonyl, n-decyl or n-dodecyl, cyclopropyl, cyclobutyl, cyclopentyl, cyclohexyl, cycloheptyl, cyclooctyl, cyclononyl or cyclododecyl, a C₂-C₁₀-alkenyl, which may be linear, cyclic or branched and in which the double bond may be internal or terminal, e.g. vinyl, 1-allyl, 2-allyl, 3-allyl, butenyl, pentenyl, hexenyl, cyclopentenyl, cyclohexenyl, cyclooctenyl or cyclooctadienyl, an alkylaryl having 1-10 carbon atoms in the alkyl part and 6-20 carbon atoms in the aryl part, e.g. benzyl, o-, m-, p-methylbenzyl, 1- or 2-ethylphenyl, or a C₆-C₁₈-aryl, which may be substituted by further alkyl groups, e.g. phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, 2-biphenyl, o-, m-, p-methylphenyl, 2,3-, 2,4-, 2,5- or 2,6-dimethylphenyl, 2,3,4-, 2,3,5-, 2,3,6-, 2,4,5-, 2,4,6- or 3,4,5-trimethylphenyl, where two groups R may also be joined to form a 5- or 6-membered ring and the organic radicals R may also be substituted by halogens such as fluorine, chlorine or bromine.

X is a variable to which reference is made a number of times in the description: X are each, independently of one another, a fluorine, chlorine, bromine, iodine or hydrogen atom, amide NR₂, alkoxide OR, thiolate SR, sulfonate SO₃R or carboxylate OC(O)R, where R is as defined above. Examples of NR₂ are dimethylamino, diethylamino and diisopropylamino; examples of OR are methoxy, ethoxy, isopropoxy, butoxy, hexoxy and 2-ethylhexoxy; examples of SO₃R are methylsulfonate, trifluoromethylsulfonate and toluenesulfonate; and examples of OC(O)R are formate, acetate and propionate.

Particular preference is given to using magnesium compounds MgR₂, e.g. dimethylmagnesium, diethylmagnesium, dibutylmagnesium, dibenzylmagnesium, (butyl)(ethyl)magnesium or (butyl)(octyl)magnesium, because of, among other things, their good solubility. (n-Butyl)(ethyl)magnesium is particularly preferred. In mixed compounds such as (butyl)(octyl)magnesium, the radicals R can be present in various ratios to one another; thus, for example, (butyl)_{1.5}(octyl)_{0.5}magnesium is often used.

Step A) can be carried out in any aprotic solvent. Particularly useful solvents are aliphatic and aromatic hydrocarbons in which the magnesium compound is soluble, e.g. pentane, hexane, heptane, octane, isooctane, nonane, dodecane, cyclohexane, benzene or a C₇-C₁₀-alkylbenzene such as toluene, xylene or ethylbenzene. A particularly preferred solvent is heptane.

It is usual to slurry the inorganic metal oxide in the aliphatic or aromatic hydrocarbon and to add the organometallic compound thereto. The magnesium compound can be added as a pure substance but is preferably added as a solution in an aliphatic or aromatic hydrocarbon, e.g. pentane, hexane, heptane or toluene. However, it is also possible to add the solution of the organometallic compound to the dry inorganic metal oxide. Reaction step A) can be carried out at from 0 to 100° C., preferably from 20 to 70° C. The reaction times are generally in the range from 1 minute to 10 hours, preferably from 5 minutes to 4 hours.

The magnesium compound is usually used in an amount of from 0.3 to 20 mmol, preferably from 1 to 10 mmol and particularly preferably from 1 to 5 mmol, per g of inorganic metal oxide.

The intermediate obtained from reaction step A) is, preferably without intermediate isolation, reacted with a halogenating reagent in step B). Suitable halogenating reagents are compounds which can halogenate the magnesium compound used, e.g. hydrogen halides such as HF, HCl, HBr and HI, silicon halides such as tetrachlorosilane, trichloromethylsilane, dichlorodimethylsilane or trimethylchlorosilane, carboxylic acid halides, boron halides, phosphorus pentachloride, thionyl chloride, sulfuryl chloride, phosgene, nitrosyl chloride, mineral acid halides, chlorine, bromine, chlorinated polysiloxanes, alkylaluminum chlorides, aluminum trichloride, ammonium hexafluorosilicate and alkyl halides such as methyl chloride, ethyl chloride, propyl chloride, n-butyl chloride or tert-butyl chloride. Preference is given to using hydrogen halides such as HCl and HBr, silicon halides, boron halides, alkylaluminum chlorides, such as dialkylaluminum chlorides, alkylaluminum sesquichlorides and dichlorides or aluminum trichloride. A chlorinating reagent is preferably used. Very particular preference is given to HCl.

Solvents suitable for step B) are in principle the same ones as for step A). The reaction is usually carried out at from 0 to 200° C., preferably from 20 to 150° C. The reaction times are generally in the range from 1 minute to 100 hours, preferably from 10 minutes to 20 hours and particularly preferably from 30 minutes to 10 hours.

The molar ratio of halogenating reagent used to magnesium compound used is generally in the range from 4:1 to 0.05:1, preferably from 3:1 to 0.5:1 and particularly preferably from 2:1 to 1:1. In this way, the magnesium compound can be partially or fully halogenated. The magnesium compound is preferably fully halogenated.

The amount of magnesium halide deposited is generally from 1 to 200% by weight of the inorganic metal oxide, preferably from 1 to 100% by weight of the inorganic metal oxide and particularly preferably from 1 to 10% by weight of the inorganic metal oxide. The magnesium halide is generally distributed uniformly over the inorganic metal oxide. The preferred magnesium halide is magnesium chloride.

The inorganic metal oxide with the magnesium halide deposited thereon which is obtainable in this way can then be used without further work-up for step C). However, it is preferably isolated. This can be achieved by, for example, distilling off the solvent or preferably by filtration and washing with an aliphatic hydrocarbon such as pentane, hexane or heptane. This can be followed by a drying step in which residual solvent is completely or partly removed.

The intermediate obtained in step B) is, in step C), brought into contact with a) a tetravalent titanium compound, b) an organometallic compound of group 3 of the Periodic Table and c), if desired, an electron donor compound.

Tetravalent titanium compounds used are generally compounds of tetravalent titanium of the formula (RO)ₛX₄₋ₛTi, where the radicals R and X are as defined above and s is from 0 to 4. Suitable compounds are, for example, tetraalkoxytitaniums such as tetramethoxytitanium, tetraethoxytitanium, tetrapropoxytitanium, tetraisopropoxytitanium, tetrabutoxytitanium and titanium(IV) 2-ethylhexoxide, trialkoxytitanium halides such as titanium chloride triisopropoxide and titanium tetrahalides. Preference is given to titanium compounds in which X is fluorine, chlorine, bromine or iodine, among which chlorine is particularly preferred. Very particular preference is given to using titanium tetrachloride.

Suitable organometallic compounds of group 3 of the Periodic Table are, for example, compounds MRₘX₃₋ₘ, where R is as defined above, M is a metal of group 3 of the Periodic Table, preferably B, Al or Ga and particularly preferably Al, and m is 1, 2 or 3.

As organometallic compound of group 3 of the Periodic Table, preference is given to using an aluminum compound AlRₘX₃₋ₘ, where the variables are as defined above. Suitable compounds are, for example, trialkylaluminum compounds such as trimethylaluminum, triethylaluminum, triisobutylaluminum or tributylaluminum, dialkylaluminum halides such as dimethylaluminum chloride, diethylaluminum chloride or dimethylaluminum fluoride, alkylaluminum dihalides such as methylaluminum dichloride or ethylaluminum dichloride, or mixtures such as methylaluminum sesquichloride. It is also possible to use the hydrolysis products of aluminum alkyls with alcohols. Preference is given to using dialkylaluminum halides and particular preference is given to using dimethylaluminum chloride or diethylaluminum chloride.

Electron donor compounds can optionally be used in step C). Examples of suitable electron donor compounds are monofunctional and polyfunctional carboxylic acids, carboxylic anhydrides and carboxylic esters, also ketones such as diethyl ketone, ethers such as dibutyl ether or tetrahydrofuran, alcohols, lactones and also organophosphorus and organosilicon compounds. The use of an electron donor compound or a mixture thereof is preferred. Pyridine and substituted pyridines are also suitable as donors. Preferred electron donor compounds are alkyl-substituted pyridines in which the pyridine ring may bear 1-5 alkyl substituents selected independently from among linear, branched and cyclic C₁-C₂₀-alkyls such as methyl, ethyl, n-propyl, isopropyl, n-butyl, sec-butyl, isobutyl, tert-butyl, n-pentyl, sec-pentyl, isopentyl, n-hexyl, n-heptyl, n-octyl, n-nonyl, n-decyl or n-dodecyl, cyclopropyl, cyclobutyl, cyclopentyl, cyclohexyl, cycloheptyl, cyclooctyl, cyclononyl or cyclododecyl. The pyridine ring is preferably substituted in the 2 and 6 positions, e.g. 2,6-dimethylpyridine, 2,4,6-trimethylpyridine, 2,3,6-trimethylpyridine, 2,5,6-trimethylpyridine, 2,6-diethylpyridine, 2,4,6-triethylpyridine, 2-ethyl-6-methylpyridine, 2,6-dimethyl-4-ethylpyridine, 2,6-diethyl-4-methylpyridine, 2,6-dipropylpyridine, 2,6-dibutylpyridine, 2,6-dihexylpyridine, 2,6-diheptylpyridine or 2,6-dioctylpyridine.

The intermediate obtained from step B), hereinafter referred to as IB, can be brought into contact with the components a), b) and, if desired, c) in any order or simultaneously. Thus, for example,
1) IB can be brought into contact with a) and the resulting product can, if desired, be brought into contact with c), if desired, and then with b), or
2) IB can, if desired, firstly be brought into contact with c) and the resulting product can subsequently be brought into contact with a) and then b), or
3) IB can be brought into contact with a), then with b) and subsequently, if desired, with c).

When using an electron donor compound, this is preferably firstly brought into contact with a) and the reaction product obtained in this way is reacted with IB and subsequently with b).

The usual procedure is to slurry the IB in a suspension medium and to add the components a), b) and, if desired, c) thereto. However, it is also possible, for example, to dissolve/suspend the components a), b) and, if desired, c) in the suspension medium and subsequently to add this solution/suspension to the IB. The titanium compound is preferably soluble in the suspension medium. Suitable suspension media are, in particular, aliphatic and aromatic hydrocarbons such as pentane, hexane, heptane, octane, dodecane, benzene or a C₇-C₁₀-alkylbenzene such as toluene, xylene or ethylbenzene.

Step C) is usually carried out at from 0 to 150° C., preferably from 0 to 100° C. and particularly preferably from 20 to 70° C. The reaction times are generally in the range from 1 minute to 20 hours, preferably from 10 minutes to 10 hours and particularly preferably from 30 minutes to 5 hours.

The molar ratio of titanium compound used to magnesium compound used is generally in the range from 10:1 to 0.01:1, preferably from 2:1 to 0.03:1 and particularly preferably from 1:1 to 0.06:1.

The organometallic compound b) is usually used in such an amount that the ratio of b) to a) in the catalyst (after step D)) is in the range from 0.1:1 to 100:1, preferably from 0.2:1 to 50:1 and particularly preferably from 1:1 to 20:1.

In general, the ratio of titanium compound a) to electron donor compound c) in the catalyst (after step D)) is set so as to be in the range from 1:0 to 1:100, preferably from 1:0 to 1:10 and particularly preferably from 1:0 to 1:5.

After step C), the solvent is preferably removed from the catalyst system, e.g. by distilling off the solvent or by filtration.

The catalyst system obtained in this way is subsequently, in step D), washed one or more times with an aliphatic or aromatic hydrocarbon such as pentane, hexane, heptane, octane, nonane, decane, dodecane, cyclohexane, benzene or a C₇-C₁₀-alkylbenzene such as toluene, xylene or ethylbenzene. Preference is given to using aliphatic hydrocarbons, in particular pentane, n-hexane or isohexane, n-heptane or isoheptane. Step D) is usually carried out at from 0 to 200° C., preferably from 0 to 150° C. and particularly preferably from 20 to 100° C., for from 1 minute to 20 hours, preferably for from 10 minutes to 10 hours and particularly preferably for from 30 minutes to 5 hours. In this step, the catalyst is stirred in the solvent and then filtered off. This step is preferably repeated once or twice. Instead of a plurality of successive washing steps, the catalyst can also be washed by extraction, e.g. in a Soxhlet apparatus, thereby achieving continuous washing.

Step D) is preferably followed by a drying step in which residual solvent is completely or partly removed. The catalyst system of the invention obtained in this way can be completely dry or have a certain residual moisture content. However, the volatile constituents should be present in an amount of not more than 20% by weight, in particular not more than 10% by weight, based on the catalyst system.

The novel catalyst system which can be obtained in this way advantageously has a titanium content of from 0.1 to 30% by weight, preferably from 0.5 to 10% by weight and particularly preferably from 0.7 to 3% by weight, and a magnesium content of from 0.1 to 30% by weight, preferably from 0.5 to 20% by weight and particularly preferably from 1 to 10% by weight. The aluminum content is preferably in a range from 0.1 to 30% by weight, preferably from 0.5 to 20% by weight and particularly preferably from 2 to 10% by weight.

The process for the polymerization or copolymerization of olefins in the presence of at least one catalyst system according to the present invention and, if desired, an aluminum compound as cocatalyst is carried out at from 20 to 150° C. and pressures of from 1 to 100 bar.

The molar mass of the polyalk-1-enes formed can be controlled and adjusted over a wide range by addition of regulators customary in polymerization technology, for example hydrogen. Furthermore, the output of products can be varied via the amount of Ziegler catalyst metered in. The (co)polymers discharged from the reactor can then be conveyed into a deodorization or deactivation vessel where they are subjected to a customary and known treatment with nitrogen and/or steam.

A particularly preferred polymerization method is suspension polymerization, in which the suspension is usually carried out in a suspension medium, preferably an alkane such as propane, isobutane or pentane. The polymerization temperatures are generally in the range from 20 to 115° C., and the pressure is generally in the range from 1 to 100 bar. The solids content of the suspension is generally in the range from 10 to 80%. The process can be carried out either batchwise, e.g. in stirring autoclaves, or continuously, e.g. in tube reactors, preferably in loop reactors. In particular, the polymerization can be carried out by the Phillips PF process, as described in U.S. Pat. No. 3,242,150 and U.S. Pat. No. 3,248,179.

Various olefinically unsaturated compounds can be polymerized by the process of the present invention. Both homopolymerizations and copolymerizations are possible. Olefins which can be used include ethylene and α-olefins having from 3 to 12 carbon atoms, e.g. propene, 1-butene, 1-pentene, 1-hexene, 1-heptene, 1-octene, 1-nonene, 1-decene or 1-dodecene, and also nonconjugated and conjugated dienes such as butadiene, 1,5-hexadiene or 1,6-heptadiene, cyclic olefins such as cyclohexene, cyclopentene or norbornene and polar monomers such as acrylic esters, acrolein, acrylonitrile, vinyl ethers, allyl ethers and vinyl acetate. Vinylaromatic compounds such as styrene can also be polymerized by the process of the present invention. Preference is given to polymerizing at least one olefin selected from the group consisting of ethene, propene, 1-butene, 1-pentene, 1-hexene, 1-heptene, 1-octene and 1-decene, in particular ethene. In a preferred embodiment of the process of the present invention, mixtures of ethylene with C₃-C₁₂-α-olefins, in particular with C₃-C₈-α-monoolefins, are copolymerized (this also includes mixtures of three or more olefins). In a further preferred embodiment of the process of the present invention, ethylene is copolymerized together with an olefin selected from the group consisting of propene, 1-butene, 1-pentene, 1-hexene, 1-heptene and 1-octene. Particularly these last-known olefins can, in the liquefied or liquid state, also form the suspension medium or solvent in the polymerization or copolymerization reaction.

Some of the catalyst systems of the present invention have little or no polymerization activity on their own and are then brought into contact with an aluminum compound as cocatalyst in order to be able to display good polymerization activity. Aluminum compounds which are suitable as cocatalysts are first and foremost compounds of the formula AlRₘX₃₋ₘ, where the variables are as defined above. In particular, compounds suitable as cocatalyst include trialkylaluminums and also compounds of this type in which one or two alkyl groups are replaced by an alkoxy group, in particular C₁-C₁₀-dialkylaluminum alkoxides such as diethylaluminum ethoxide, or by one or two halogen atoms, for example by chlorine or bromine, in particular dimethylaluminum chloride, methylaluminum dichloride, methylaluminum sesquichloride or diethylaluminum chloride. Preference is given to using trialkylaluminum compounds whose alkyl groups each have from 1 to 15 carbon atoms, for example trimethylaluminum, methyldiethylaluminum, triethylaluminum, triisobutylaluminum, tributylaluminum, trihexylaluminum or trioctylaluminum. Cocatalysts of the aluminoxane type can also be used, in particular methylaluminoxane MAO. Aluminoxanes are prepared by, for example, controlled addition of water to alkylaluminum compounds, in particular trimethylaluminum. Aluminoxane preparations suitable as cocatalyst are commercially available.

The amount of aluminum compounds to be used depends on their effectiveness as cocatalyst. Since many of the cocatalysts are at the same time used for removing catalyst poisons (they act as scavengers), the amount used depends on the degree of contamination of the other starting materials. However, the optimum amount can be determined by a person skilled in the art by means of simple experiments. The cocatalyst is preferably used in such an amount that the atomic ratio of aluminum from the aluminum compound used as cocatalyst to titanium from the catalyst system of the present invention is from 10:1 to 800:1, in particular from 20:1 to 200:1.

The various aluminum compounds can be used individually in any order or as a mixture of two or more components as cocatalyst. Thus, these aluminum compounds acting as cocatalysts can be allowed to act either in succession or together on the catalyst systems of the present invention. The catalyst system of the present invention can be brought into contact with the cocatalyst or cocatalysts either before or after it is brought into contact with the olefins to be polymerized. Preactivation by means of one or more cocatalysts prior to mixing with the olefin and further addition of the same or other cocatalysts after the preactivated mixture has been brought into contact with the olefin is also possible. Preactivation is usually carried out at from 0 to 150° C., in particular from 20 to 80° C., and pressures of from 1 to 100 bar, in particular from 1 to 40 bar.

The process of the present invention makes it possible to prepare olefin polymers having molar masses in the range from about 10,000 to 5,000,000, preferably from 20,000 to 1,000,000, with the polymers having molar masses (weight average) in the range from 20,000 to 400,000 being particularly preferred.

The catalyst system of the present invention displays a considerably longer production period without deposit formation compared to the same catalyst system without step D).

### EXAMPLES AND COMPARATIVE EXPERIMENTS

### Example 1

Preparation of the Catalyst System According to the Present Invention

Steps A) to C) of the preparation of the catalyst were carried out as described in WO 97/48742. The resulting catalyst, which had a magnesium content of 3% by weight, an aluminum content of 5% by weight and a titanium content of 1.4% by weight, was subsequently subjected to step D), which was carried out under a nitrogen atmosphere. For this purpose, 3 l of heptane were placed in a vessel and 500 g of the catalyst were added while stirring. The suspension obtained in this way was stirred at 90° C. for 1 hour. A further 2 l of heptane were then added and the mixture was stirred for another 5 minutes. The solid was subsequently filtered off and resuspended in 3 l of heptane. After stirring for 30 minutes at room temperature, the solid was filtered off again and the catalyst obtained in this way was suspended in 1.21 l of heptane and used directly as a suspension. The washing steps at 90° C. and room temperature can be repeated once or twice if required.

### Example 2 (According to the Present Invention) and 3 (Comparative Example)

Polymerization

The polymerizations were carried out in a 30 m³ loop reactor at an internal reactor temperature of 95° C. and a reactor pressure of 41 bar using isobutane as solvent. The polymerizations were carried out continuously for one week and the power uptake of the reactor pump (centrifugal pump) which circulates the polymerization mixture in the loop reactor was observed. Example 2 was carried out using the catalyst according to the present invention from example 1. Comparative example 3 was carried out using the unwashed intermediate from example 1, namely the catalyst prepared as described in WO 97/48742 without washing step D). In the case of both catalysts, a product having a density of 0.950 was produced by addition of from 28 to 30 m³/h of hydrogen and from 56 to 80 kg/h of hexene.

Table 1 below shows the output rate and the power uptake of the reactor pump both for example 2 according to the present invention and for comparative example 3. When using the catalyst according to the present invention, the power uptake of the reactor pump remained constant during the running time of one week, while it increased continually over the one week period in comparative example 3, which is attributable to the deposits being formed in the reactor. Despite the washing step D), the catalyst according to the present invention displayed the same productivity as the catalyst which had not been purified.

TABLE 1
Preparation of polymers using the catalyst system of the
present invention (example 2) and using a catalyst system which
is not according to the present invention (comparative example 3)

| | Output rate | Power uptake of reactor pump |
|---|---|---|
| Example No. | [kg/h] | [kW] |
| 2 | 5400 | 235 |
| 3 (C) | 4300 | 235-265 |

1. A process for preparing catalyst systems of the Ziegler-Natta type, which consists of the following steps:
A) bringing an inorganic metal oxide into contact with a magnesium compound MgRₙX₂₋ₙ,
where X are each, independently of one another, fluorine, chlorine, bromine, iodine, hydrogen, NR₂, OR, SR, SO₃R or OC(O)R, and R are each, independently of one another, a linear, branched or cyclic C₁-C₂₀-alkyl, a C₂-C₁₀-alkenyl, an alkylaryl having 1-10 carbon atoms in the alkyl part and 6-20 carbon atoms in the aryl part or a C₆-C₁₈-aryl and n is 1 or 2,
and subsequently
B) bringing the intermediate obtained after step A) into contact with a halogenating reagent,
C) bringing the intermediate obtained after step B) into contact with
a) a tetravalent titanium compound,
b) an organometallic compound of group 3 of the Periodic Table and
c) optionally an electron donor compound,
and
D) washing the product obtained in step C) with an aprotic solvent.

2. A process for preparing catalyst systems as claimed in claim 1, wherein a magnesium compound MgR₂ is used in step A).

3. A process for preparing catalyst systems as claimed in claim 1, wherein the halogenating reagent used in step B) is hydrogen chloride.

4. A process for preparing catalyst systems as claimed in claim 1, wherein the inorganic metal oxide used in step A) is a silica gel.

5. A process for preparing catalyst systems as claimed in claim 1, wherein the tetravalent titanium compound used in step C) is titanium tetrachloride.

6. A process for preparing catalyst systems as claimed in claim 1, wherein the organometallic compound of group 3 of the Periodic Table in step C) is an aluminum compound AlRₘX₃₋ₘ, where the variables are as defined in claim 1 and m is 1, 2 or 3.

7. A process for preparing catalyst systems as claimed in claim 1, wherein the aprotic solvent in step D) is an aliphatic hydrocarbon.

8. A catalyst system of the Ziegler-Natta type which can be prepared by a process as claimed in claim 1.

9. A process for the polymerization or copolymerization of olefins in suspension or solution at from 20 to 150° C. and pressures of from 1 to 100 bar, wherein the polymerization or copolymerization is carried out in the presence of at least one catalyst system as claimed in claim 8 and optionally an aluminum compound as cocatalyst.

10. A process for the polymerization or copolymerization of olefins as claimed in claim 9, wherein a trialkylaluminum compound whose alkyl groups each have from 1 to 15 carbon atoms is used as aluminum compound.
